(19) United States
(12) Patent Application Publication
(10) Pub. No.: US 2004/0197101 A1
(43) Pub. Date: Oct. 7, 2004

(54) Optical transceiver module with host accessible on-board diagnostics

(76) Inventors: Gary D. Sasser, San Jose, CA (US); Lewis B. Aronson, Los Altos, CA (US); Stephen T. Nelson, Cupertino, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/820,250

(22) Filed: Apr. 8, 2004

Related U.S. Application Data
(63) Continuation-in-part of application No. 09/777,917, filed on Feb. 5, 2001.
(60) Provisional application No. 60/462,034, filed on Apr. 9, 2003.

(51) Int. Cl. G02F 1/00

(52) U.S. Cl. 398/117

(57) ABSTRACT

A small form factor optical transceiver module is provided that includes a housing within which are disposed an optical transmitter and an optical receiver. A controller IC is also disposed in the housing and includes a serial digital interface configured to facilitate communication between the controller IC and a host. Among other things, the serial digital interface enables access to onboard digital diagnostics while substantially conforming with the standardized packaging, footprint, and form factor of a standardized optical transceiver module. Further, the use of memory map locations in the controller IC enables the implementation of various types of host accessible diagnostic and other finctionalities in the optical transceiver module.

### CROSS-REFERENCE TO RELATED APPLICATIONS

This application claims the benefit of: United States Provisional Patent Application Serial No. 60/462,034, entitled OPTICAL TRANSCEIVER MODULE WITH HOST ACCESSIBLE ON-BOARD DIAGNOSTICS, filed Apr. 9, 2003; and, U.S. patent application Ser. No. 09/777,917, entitled INTEGRATED MEMORY MAPPED CONTROLLER CIRCUIT FOR FIBER OPTICS TRANSCEIVER, filed Feb. 5, 2001, both of which are incorporated herein in their respective entireties by this reference.

### BACKGROUND

1. Technological Field

This invention is generally concerned with optical transceivers. More particularly, embodiments of the invention relate to an optical transceiver module having a uniform system architecture and associated communication mechanism that enable the optical transceiver module to implement a wide range of diagnostic, and other, finctionalities, as well as to communicate diagnostic information and other information to a host.

2. Related Technology

Optical communication networks depend in large part for their functionality upon optical transceiver modules. In general, optical transceiver modules are configured to receive and transmit data. To this end, typical optical transceiver modules include a laser driver circuit, which is generally configured to receive high speed digital data, in electrical form, and electrically drive an optical transmitter, such as a laser diode, so that the optical transmitter generates an optical signal that corresponds to the high speed electrical digital data input signal. In addition, the optical transceiver module includes a corresponding receiver circuit which receives relatively small signals from an optical detector, such as a photodiode, and amplifies and limits those signals in order to create a digital electronic output of uniform amplitude.

Typical optical transceiver modules may perform some other functions as well. For example, some optical transceiver modules perform various setup functions that generally relate to the required adjustments made on a part-to-part basis in the factory to allow for variations in component characteristics such as laser diode threshold current. Yet other functions relate to the use of general purpose memory, typically EEPROM (electrically erasable and programmable read only memory) or other nonvolatile memory, in the performance of various identification processes. In general, the memory is accessible by way of a serial communication bus that conforms to an industry standard. The memory is used to store various information identifying the transceiver type, capability, serial number, and compatibility with various standards.

Some other functions performed by optical transceivers relate to eye safety and general fault detection. In general, such functions are used to identify abnormal and potentially unsafe operating parameters and to report these to the user and/or perform laser shutdown, as appropriate.

While the aforementioned functions have proven useful, such a limited set of functions or capabilities is inadequate to deal with the wide scope of issues that relate to the operation of optical transceivers in an optical communications network. The limited functionality of typical optical transceivers is due at least in part to the fact that implementation of more comprehensive functionality has proven to be expensive in many cases.

Some attempts have been made to enhance the functionality of optical transceivers. For example, some limited functions have been implemented in optical transceivers using discrete circuitry, such as using a general purpose EEPROM for identification purposes, or by inclusion of some functions within the laser driver or receiver circuitry such as, for example, basic temperature compensation in a laser driver circuit. In other cases, commercial micro-controller integrated circuits have been employed to implement some limited enhancements to the functionality of some known optical transceivers.

Such attempts to enhance the functionality of typical optical transceivers have met with only limited success however. For example, typical optical transceivers lack a uniform device architecture for supporting the implementation of additional functionality. Thus, not only is it often cost prohibitive to include enhanced functionality in an optical transceiver, but many optical transceivers are not configured to accommodate or enable enhancements in any event.

A related problem with conventional optical transceivers is that any additional functionality desired to be implemented must be implemented in such a way that the optical transceiver maintains conformance with the packaging and size limitations laid out in the various transceiver platform standards. By way of example, most small optical transceivers are either Small Form Factor (“SFF”) or Small Form Factor Pluggable (“SFP”) optical transceivers.

Among other things, these standardized sizes of optical transceiver modules provide for interchangeability of the optical transceiver modules within larger electronic components. However, it is also the case that as additional functionality is added beyond that required by the transceiver platform standards, the circuitry required for such additional functionality must nonetheless fit within the same standardized package. Consequently, the standardized package form factor constrains the amount of additional circuitry, and associated functionality, that can be added to standardized optical transceivers.

Another concern with conventional optical transceivers relates to the input and output (“I/O”) pins or connectors of those standardized optical transceivers. In general, the I/O pin configuration is governed by the transceiver platform standards. For example, conventional SFF transceivers have two basic I/O pin configurations, namely, a 2×5 pin configuration and a 2×10 pin configuration, where 2×5 indicates two rows of five pins and 2×10 indicates two rows of ten pins. The functionality of each of these pins is also generally dictated by the transceiver platform standards.

The transceiver platform standards thus operate to restrict, if not prevent, access to additional functionality from an external host, since the standardized number of pins only provide for the I/O requirements of the standard optical transceiver module and are not configured or intended to facilitate implementation of, nor access to, additional functionality.

In view of the foregoing, and other, problems in the art, what is needed is an optical module having a flexible and adaptable system architecture that enables ready implementation of functional enhancements to the optical transceiver. Additionally, embodiments of the optical module should also employ a simple but effective communication mechanism so that information concerning processes performed by or in connection with the optical module can be readily and effectively communicated to a host and/or other recipient. As well, implementations of the optical module should maintain conformance with established form factors and other standards.

### BRIEF SUMMARY OF AN EXEMPLARY EMBODIMENT OF THE INVENTION

In general, embodiments of the invention are concerned with an optical transceiver module having a uniform system architecture and associated communication mechanism. More particularly, exemplary embodiments of the invention are directed to an optical transceiver having a memory mapped architecture and a simple serial communication mechanism that enable, among other things, host access to digital diagnostics of the optical transceiver.

In one exemplary implementation, the optical transceiver module is implemented as a 2×6 Small Form Factor (“SFF”) transceiver and includes a housing wherein a transmit optical subassembly and associated laser driver are disposed. Also disposed within the housing is a receive optical subassembly and associated post-amplifier. A controller IC is provided that communicates with the post-amplifier and laser driver so as to control the operations of the transmit optical subassembly and receive optical subassembly.

The exemplary optical transceiver module also includes a digital serial interface, implemented as a pair of pins that extend downward from the bottom of the housing and generally facilitate serial communication between the controller and a host device so that the controller can transmit, for example, digital diagnostic information to the host. The serial digital interface thus enables host access to onboard digital diagnostics while also allowing substantial conformance with the standardized packaging, footprint, and form factor of an SFF optical transceiver module.

Thus, exemplary embodiments of the optical transceiver module include additional functionality, such as digital diagnostics, that can be accessed by a host via a suitable communication mechanism. At the same time, the optical transceiver module maintains substantial conformance with established configuration, and other, standards.

### BRIEF DESCRIPTION OF THE DRAWINGS

In order that the manner in which the above-recited and other aspects of the invention are obtained, a more particular description of the invention will be rendered by reference to specific embodiments thereof which are illustrated in the appended drawings. Understanding that these drawings depict only exemplary embodiments of the invention and are not, therefore, to be considered limiting of its scope, the invention will be described and explained with additional specificity and detail through the use of the accompanying drawings in which:

FIG. 1 is a block diagram illustrating various aspects of an exemplary implementation of an optical transceiver module;

FIG. 2 is a block diagram that illustrates aspects of an exemplary embodiment of a controller IC suitable for use in connection with an optical transceiver module;

FIG. 3 is a block diagram that provides additional details concerning the connections between the controller IC, and the laser driver and post-amplifier;

FIG. 4A is a top view of an exemplary implementation of an optical transceiver module;

FIG. 4B is a front view of the exemplary implementation of an optical transceiver module of FIG. 4A, illustrating the arrangement of a transmit optical subassembly and receive optical subassembly, as well as portions of an exemplary pin arrangement;

FIG. 4C is a side view that partially illustrates a pin arrangement of the exemplary optical transceiver module of FIG. 4A;

FIG. 4D is a bottom view of the optical transceiver module of FIG. 4A, illustrating an exemplary pin arrangement;

FIG. 5A is a top view of an alternative implementation of an optical transceiver module;

FIG. 5B is a front view of the exemplary optical transceiver module of FIG. 5A, illustrating the arrangement of a transmit optical subassembly and a receive optical subassembly, as well as portions of an exemplary pin arrangement;

FIG. 5C is a side view that partially illustrates a pin arrangement of the exemplary optical transceiver module of FIG. 5A;

FIG. 5D is a bottom view of the optical transceiver module of FIG. 5A, illustrating an exemplary pin arrangement;

FIG. 6A is a top view of an another alternative implementation of an optical transceiver module;

FIG. 6B is a front view of the exemplary optical transceiver module of FIG. 6A, illustrating the arrangement of a transmit optical subassembly and a receive optical subassembly, as well as portions of an exemplary pin arrangement;

FIG. 6C is a side view that partially illustrates a pin arrangement of the exemplary optical transceiver module of FIG. 6A; and

FIG. 6D is a bottom view of the optical transceiver module of FIG. 6A, illustrating an alternative pin arrangement.

### DETAILED DESCRIPTION OF EXEMPLARY EMBODIMENTS OF THE INVENTION

As noted earlier, exemplary embodiments of the invention are directed to optical modules that include functionality, such as digital diagnostics, that can be accessed by an external host via a suitable communication mechanism. At the same time, the optical module maintains substantial conformance with established configuration standards.

I. General Aspects of Exemplary Optical Transceiver Modules

In at least one exemplary implementation, the accessibility of optical transceiver module functionality such as digital diagnostics is afforded by a serial interface, exemplified as a two pin connection, that enables communication between a controller IC of the transceiver module and an external device, such as a host. The two pins supplement a 2×5 array of substantially parallel pins configured in two substantially parallel rows of pins, where each row includes six pins, for a total of twelve pins.

Generally, each of the twelve pins corresponds to a particular functionality. In particular, the pin finctionalities are assigned as follows: the first pin is a serial communication data pin; the second pin is a receiver ground pin; the third pin is a receiver power pin; the fourth pin is a signal detect pin; the fifth pin is a receive data inverted pin; the sixth pin is a receive data pin; the seventh pin is a serial communication clock pin; the eighth pin is a transmitter power pin; the ninth pin is a transmitter ground pin; the tenth pin is a transmitter disable pin; the eleventh pin is a transmit data pin; and, the twelfth pin is a transmit data inverted pin.

Embodiments of the invention are thus distinct from standard optical transceiver modules in that, among other things, the aforementioned first and seventh pins are “additional pins” that are not present in typical optical transceiver modules. In some alternative implementations, any given pin may perform, or otherwise be associated with, a particular function. In particular, each pin may be used as a serial communication data pin, a receiver ground pin, a receiver power pin, a signal detect pin, a receive data inverted pin, a receive data pin, a serial communication clock pin, a transmitter power pin, a transmitter ground pin, a transmitter disable pin, a transmit data pin, a transmit data inverted pin, a loss of signal pin, or an interrupt pin.

As the foregoing thus suggests, exemplary embodiments of the optical transceiver module are configured to implement a variety of types and combinations of host accessible functions. Examples of such functions include, but are not limited to, temperature compensation functions, such as compensating for known temperature variations in key laser characteristics such as slope efficiency, as well as monitoring functions, such as monitoring various parameters, also referred to herein as “diagnostic parameters,” related to the transceiver operating characteristics and environment.

With respect to “parameters,” or “diagnostic parameters,” such terms as used herein generally refer to, but are not limited to, any aspect of the performance, characteristics and/or operation of optical modules and/or their associated systems, components and devices that may be of interest in processes such as the diagnosis, evaluation and/or analysis of any of such modules, systems, components and devices. Similarly, “diagnostic parameter information” generally includes, but is not limited to, any and all information and/or data, regardless of form, concerning one or more diagnostic parameters.

Parameters that may be desirable to monitor include, among others, laser bias current, laser output power, received power level, supply voltage and temperature. In at least some implementations, these parameters are monitored and reported to, or otherwise made available to, a host device and, thus, to the user of the optical transceiver.

Embodiments of the invention also provide for the collection and storage of information concerning monitored parameters and/or other aspects of the transceiver performance, characteristics, and operation. For example, it may be useful in some applications for the transceiver memory to store information or data concerning sub-component revisions and factory test data. In a related vein, some embodiments of the transceiver are configured so that the control circuitry keeps track of the total number of hours, or other time units, that the transceiver has been in the “power on” state, and the transceiver also reports, or otherwise makes available, this time information to a host device.

At least some embodiments of the invention also permit a host to perform various affirmative actions concerning the transceiver. For example, in an exemplary embodiment, the transceiver is configured so that the host can performing “margining” operations. Generally, margining refers to a mechanism that allows the end user to test transceiver performance at a known deviation from ideal operating conditions, generally by scaling the control signals used to drive the active components of the transceiver.

As another example, some transceivers are configured so as to enable a host device to be able to configure the transceiver in such a way as to make the transceiver compatible with various requirements for the polarity and output types of digital inputs and outputs. For example, digital inputs are used for transmitter disable and rate selection functions while digital outputs are used to indicate transmitter fault and loss of signal conditions.

II. Exemplary Optical Transceiver Modules

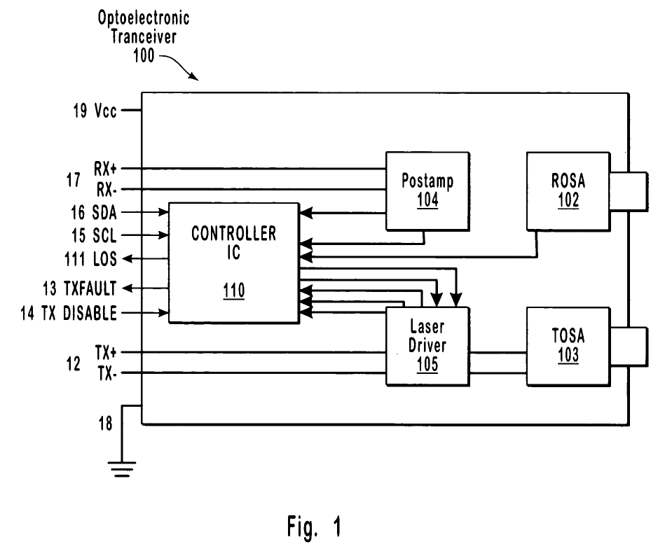

With attention now to FIGS. 1 through 3, details are provided concerning an exemplary optical transceiver module 100. The optical transceiver module, also referred to herein as a “transceiver,” or “transceiver module,” includes a receive optical subassembly (“ROSA”) 102 and transmit optical subassembly (“TOSA”) 103 along with associated post-amplifier 104 and laser driver 105 integrated circuits (“IC”) that communicate the high speed electrical signals to a host or other device.

In the illustrated implementation however, all other control and setup functions are implemented with a third single-chip integrated circuit 110 referred to as the controller IC. Exemplary embodiments of a controller IC are disclosed and claimed in U.S. patent application Ser. No. 09/777,917, entitled INTEGRATED MEMORY MAPPED CONTROLLER CIRCUIT FOR FIBER OPTICS TRANSCEIVER, filed Feb. 5, 2001, incorporated herein in its entirety by this reference.

The controller IC, or simply “controller,” 110 handles all low speed communications with the end user. These low speed communications concern, among other things, the standardized pin functions such as Loss of Signal (“LOS”) 111, Transmitter Fault Indication (“TX FAULT”) 13, and the Transmitter Disable Input (“TX DISABLE”) 14, also sometimes referred to as “TXD.” The controller IC 110 has a two wire serial interface 121 that, among other things, accesses memory mapped locations in the controller. Memory Map Tables 1, 2, 3 and 4, below, are an exemplary memory map for one embodiment of a controller 110.

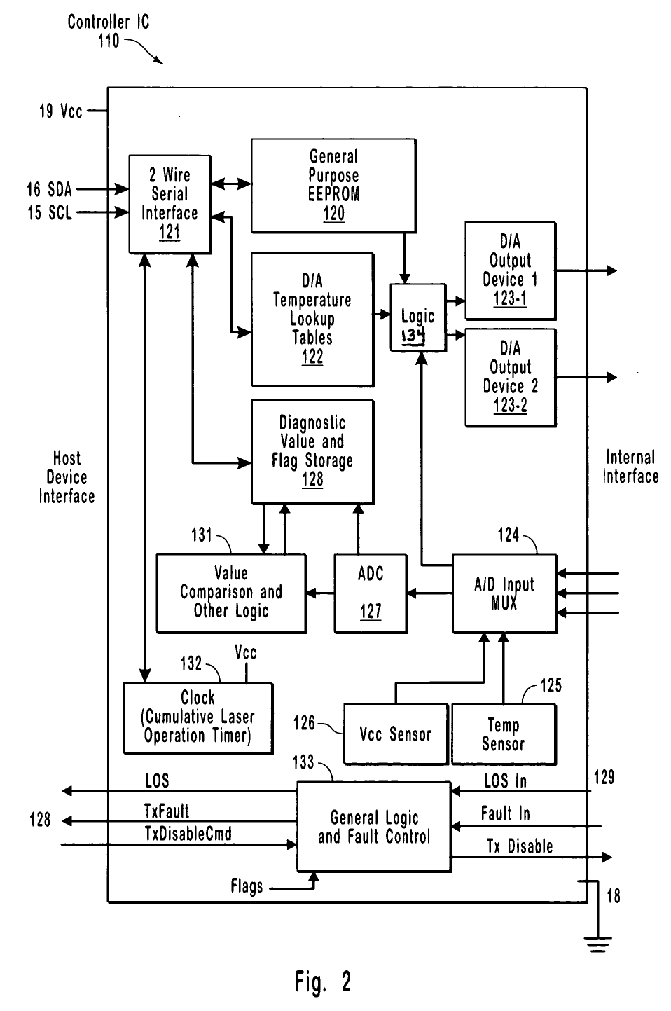

As indicated in FIG. 2, the two wire serial interface 121 of the controller 110 is coupled to host device interface input/output lines, typically clock (“SCL”) and data (“SDA”) lines 15 and 16, respectively. In at least one embodiment, the two wire serial interface 121 operates in accordance with the two wire serial interface standard that is also used in the GBIC and SFP standards, however other serial interfaces could equally well be used in alternate embodiments. Among other things, the two wire serial interface 121 is used for all setup and querying of the controller IC 110, and enables access to the optoelectronic transceiver control circuitry as a memory mapped device.

More particularly, tables and parameters are set up by writing values to predefined memory locations of one or more nonvolatile memory devices 120, 122 and 128, such as EEPROM devices for example, in the controller 110, whereas diagnostic and other output and status values are output by reading predetermined memory locations of the same nonvolatile memory devices 120, 122 and 128. This technique is consistent with serial ID functionality of many transceivers where a two wire serial interface is used to read out identification and capability data stored in EEPROM.

As suggested in the illustrated embodiment, the nonvolatile memory devices may generally be configured to provide for storage and accessibility of a variety of different types of information. With reference to nonvolatile memory device 122 for example, that device is exemplarily configured to contain D/A temperature lookup tables. Of course, a variety of other nonvolatile memory devices, configured to provide for storage and accessibility of various other types of information and data, may likewise be employed. Accordingly, the scope of the invention should not be construed to be limited to the storage and use of such exemplary information and data.

With continuing reference to the exemplary memory devices, it is noted here that some of the memory locations in the memory devices 120, 122 and 128 are dual ported, or even triple ported in some instances. That is, while these memory mapped locations can be read, and in some cases written, via the serial interface 121, such locations are also directly accessed by other circuitry in the controller 110. For example, certain margining values stored in memory device 120 are read and used directly by logic 134 to adjust, or scale upwards or downwards, drive level signals being sent to the D/A output devices 123-1 and 123-2.

Similarly, there are flags stored in memory device 128 that are written by logic circuit 131, and also read directly by logic circuit 133. An example of a memory mapped location not in memory devices but that is effectively dual ported is the output or result register of clock 132. In this case, the accumulated time value in the register is readable via the serial interface 121, but is written by circuitry in the clock 132. Note that in the illustrated implementation at least, the clock 132 tracks cumulative laser operation time.

In addition to the result register of the clock 132, other memory mapped locations in the controller 110 may be implemented as registers at the input or output of respective sub-circuits of the controller 110. As an example, the margining values used to control the operation of logic 134 may be stored in registers in, or near, logic 134 instead of being stored within memory device 128. In another example, measurement values generated by the ADC 127 may be stored in registers. The serial interface 121 is configured so as to access each of such registers whenever the serial interface 121 receives a command to access the data stored at the corresponding predefined memory mapped location. In such embodiments, “locations within the memory” includes, among other things, memory mapped registers throughout the controller 110.

In one alternative embodiment, the time value in the result register of the clock 132, or a value corresponding to that time value, is periodically stored in a memory location within the memory device 128. For example, the storage of the time value may be performed once per minute, or once per hour of device operation. In this exemplary alternative embodiment, the time value read by the host device via serial interface 121 is the last time value stored into the memory 128, as opposed to the current time value in the result register of the clock 132.

As shown in FIG. 1, the controller IC 110 has connections to the laser driver 105 and various receiver components. These connections serve multiple functions. To this end, the controller IC 110 includes a multiplicity of digital-to-analog (“D/A”) converters, sometimes also referred to as “DAC”s, such as DACs 123-1 and 123-2. In one embodiment, the D/A converters 123-1 and 123-2 are implemented as current sources, but in other embodiments, the D/A converters 123-1 and 123-2 are implemented using voltage sources, and in yet other embodiments, the D/A converters 123-1 and 123-2 are implemented using digital potentiometers. As the foregoing thus makes clear, the scope of the invention should not be construed to be limited to the use of any particular type or number of DACs.

In an exemplary embodiment, the output signals of the D/A converters 123-1 and 123-2 are used to control key parameters of the laser driver circuit 105. In one embodiment, outputs of the D/A converters 123-1 and 123-2 are use to directly control the laser bias current as well as to control the level of AC modulation to the laser (constant bias operation). In another embodiment, the outputs of the D/A converters 123-1 and 123-2 of the controller 110 control the level of average output power of the laser driver 105 in addition to the AC modulation level (constant power operation).

In at least one embodiment, the controller 110 includes mechanisms to compensate for temperature dependent characteristics of the laser. This is implemented in the controller 110 through the use of D/A temperature lookup tables 122 that are used to assign values to the control outputs as a function of the temperature measured by a temperature sensor 125 within the controller IC 110.

In alternate embodiments, the controller 110 uses D/A converters with voltage source outputs or may even replace one or more of the D/A converters 123 with digital potentiometers to control the characteristics of the laser driver 105. It should also be noted that while FIG. 1 refers to a system where the laser driver 105 is specifically designed to accept inputs from the controller 110, the controller IC 110 may, more generally, be employed in the control of the output characteristics of many other types of laser driver ICs.

In addition to temperature dependent analog output controls, the controller IC 110 may be equipped with a multiplicity of temperature independent (one memory set value) analog outputs. Such temperature independent outputs serve numerous functions. As an example, a temperature dependent output is used in at least some embodiments of the invention as a fine adjustment to other settings of the laser driver 105 or postamp 104 in order to compensate for process-induced variations in the characteristics of those devices.

One example of this might be the output swing of the receiver postamp 104. Normally, such a parameter would be fixed at design to a desired value, through the use of a set resistor. It often turns out, however, that normal process variations associated with the fabrication of the postamp integrated circuit 104 induce undesirable variations in the resulting output swing with a fixed set resistor. However, using exemplary embodiments of the present invention, an analog output of the controller IC 110, produced by an additional D/A converter 123, is used to adjust or compensate the output swing setting at manufacturing setup time on a part-by-part basis.

In addition to the connection from the controller 110 to the laser driver 105, FIG. 1 illustrates a number of connections from the laser driver 105 to the controller IC 110, as well as connections from the ROSA 102 and postamp 104 to the controller IC 110. In general, these are analog monitoring connections that the controller IC 110 uses to provide diagnostic feedback to the host device via memory mapped locations in the controller IC 110.

In at least some embodiments, the controller IC 110 has a multiplicity of analog inputs. The analog input signals serve to indicate operating conditions of the transceiver 100 and/or transceiver circuitry. These analog signals are scanned by a multiplexer 124 and converted using an analog to digital converter (“ADC” or “AID”) 127. The ADC 127 has 12 bit resolution in one exemplary embodiment, although ADCs with other resolution levels are used in other embodiments.

The converted values are stored in predefined memory locations, such as the diagnostic value and flag storage device 128 illustrated in FIG. 2 for example, and are accessible to the host device via memory reads. These values are calibrated to standard units, such as millivolts or microwatts, as part of a factory calibration procedure. The digitized quantities stored in memory mapped locations within the controller IC include, but are not limited to, the laser bias current, transmitted laser power, and received power, as measured by a photodiode detector in the ROSA 102.

In the memory map tables, such as Table 1 for example, the measured laser bias current is denoted as parameter “Bᵢₙ,” the measured transmitted laser power is denoted as “Pᵢₙ,” and the measured received power is denoted as “Rᵢₙ.” The memory map tables indicate the memory locations where, in an exemplary implementation, these measured values are stored, and the memory map tables also show where the corresponding limit values, flag values, and configuration values, such as for indicating the polarity of the flags, are stored.

As shown in FIG. 2, the exemplary controller 110 additionally includes a voltage supply sensor (“Vcc”) 126. An analog voltage level signal generated by the voltage supply sensor 126 is converted to a digital voltage level signal by the ADC 127, and the digital voltage level signal value is stored in memory device 128. In one embodiment, the A/D input multiplexer, or “MUX,” 124 and ADC 127 are controlled by a clock signal so as to automatically, periodically convert the monitored signals into digital signals, and to store those digital values in memory device 128.

Furthermore, as the digital values are thus generated, the value comparison logic 131 of the controller 110 compares these values to predefined limit values. In some cases, the limit values are stored in memory device 128 at the time of production, however, the host device may in some instances overwrite the originally programmed limit values with new limit values. Each monitored signal is automatically compared with both a lower limit value and upper limit value, resulting in the generation of two limit flag values that are then stored in the diagnostic value and flag storage memory device 128. For any monitored signals where there is no meaningful upper or lower limit, the corresponding limit value can be set to a value that will never cause the corresponding flag to be set.

The limit flags are also sometimes called alarm and warning flags. The host device, or end user, can monitor these flags to determine whether conditions exist that are likely to have caused a transceiver link to fail, an alarm flag, or whether conditions exist which predict that a failure is likely to occur relatively soon, a warning flag. An example of an alarm flag condition is a laser bias current which has fallen to zero, which is indicative of an immediate failure of the transmitter output. An example of a warning flag condition is a laser bias current, in a constant power mode, which exceeds a nominal value by more than 50%, indicating a laser end-of-life condition. Of course, any other limit values, and corresponding flags, may be defined and implemented as well.

Thus, the automatically generated limit flags are useful because they provide a simple pass-fail decision on the transceiver functionality based on internally stored limit values. In some exemplary embodiments, the general logic and fault control circuit 133 logically ORs the alarm and warning flags, along with the internal loss of signal (“LOS”) input and fault input signals, to produce a binary transceiver fault (“TxFault”) signal that is coupled to the host interface, and thus made available to the host device. The host device can be programmed to monitor the TxFault signal, and to respond to an assertion of the TxFault signal by automatically reading all the alarm and warning flags in the transceiver, as well as the corresponding monitored signals, so as to determine the cause of the alarm or warning, and to take or cause appropriate action(s).

In addition to performing the foregoing finctionalities, the general logic and fault control circuit 133 furthermore conveys an LOS signal received from the receiver circuit, or ROSA (FIG. 1) to the host device interface. Yet another function of the general logic and fault control circuit 133 is to determine the polarity of the input and output signals, of the general logic and fault control circuit 133, in accordance with a set of configuration flags stored in memory 128. For instance, the LOS output of the general logic and fault control circuit 133 may be either a logic low (“0”) or logic high (“1”) signal, as determined by a corresponding configuration flag stored in memory 128.

Other configuration flags, such as those indicated in Table 4 for example, stored in memory device 128 are used to determine the polarity of each of the warning and alarm flags. Yet other configuration values stored in memory device 128 are used to determine the scaling applied by the ADC 127 when converting each of the monitored analog signals into digital values.

In one alternative embodiment, another input to the controller 110, at the host device interface, is a rate selection signal. With reference to FIG. 2, the rate selection signal would be input to general logic and fault control circuit 133. This host generated signal is implemented as a digital signal that specifies the expected data rate of data to be received by the receiver, or ROSA 102 (FIG. 1). For instance, the rate selection signal might have two values, representing high and low data rates, such as 2.5 Gbps and 1.25 Gbps, respectively. The controller IC 110 then responds to the rate selection signal by generating control signals to set the analog receiver circuitry to a bandwidth corresponding to the value specified by the rate selection signal.

As described above, the controller IC 110 provides additional functionality including onboard diagnostics of the optical transceiver module 100 and control of components within the optical transceiver module 100, such as controlling laser bias current. In general, such additional functionality is accessed by a host device via the serial interface 121. More particularly, the controller IC 110 is coupled to a host via SCL line 15 and SDA line 16. As disclosed above, the serial interface 121 operates in accordance with the two wire serial interface standard that is also used in the GBIC and SFP standards. In at least some embodiments, the serial interface 121 is a digital I²C (“Inter-IC”) or management data input/output (“MDIO”) serial bus. An I²C bus is a bi-directional two-wire serial bus that provides a communication link between integrated circuits, whereas an MDIO bus is described by the IEEE 802.3 specification. Alternatively however, any other suitable bi-directional serial interface may be used.

The serial interface 121 is used for all setup and querying of the controller IC 110, and enables access to the optical transceiver module 100 control circuitry as a memory mapped device. More specifically, tables and parameters are set up by writing values to predefined memory locations of one or more nonvolatile memory devices 120, 122 and 128, such as EEPROM devices for example, in the controller IC 110, whereas diagnostic and other output and status values are output by reading predetermined memory locations of the same nonvolatile memory devices 120, 122 and 128.

As noted earlier, one of the most prevalent types of standardized optical transceivers is the Small Form Factor (“SFF”) optical transceiver. Such SFF optical transceivers have a standard “footprint” and typically include either 2×5 or 2×10 pin arrays. The 2×5 pin arrays have two parallel rows of five pins each, while the 2×10 pin arrays have two parallel rows of ten pins each. The function of each of these pins is typically governed by industry standards. However, as described above, it is useful to access the serial interface 121 of the controller IC 110 via the SCL line 15 and SDA line 16.

Specifically, it is useful to be able to directly access memory mapped locations within the optical transceiver module 100 via the SCL line 15 and the SDA line 16. Accordingly, exemplary embodiments of the present invention provide a mechanism for accessing the controller IC 110 while maintaining substantial conformance with the standardized SFF footprint and pin layout. With the foregoing in view, attention is directed now to various exemplary embodiments of an optical transceiver 100 configured to these ends.

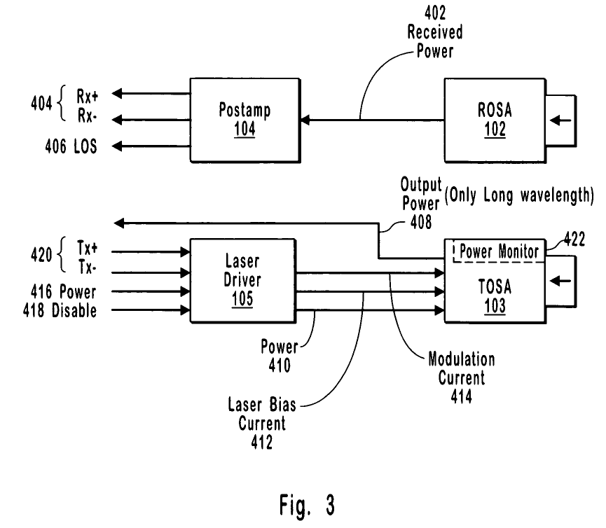

Directing attention briefly now to FIG. 3, further details are provided concerning various signals relating to the ROSA 102, TOSA 103, postamp 104 and laser driver 105. With attention first to the transmit side, the laser driver 105 is configured to receive data signals 420 in electrical form, denoted as comprising the channels TX+and TX−. In addition to receiving input data signals, the laser driver 105 also is configured to receive, and act upon, a TxDISABLE signal 418 which, as noted earlier, may be generated and transmitted by a host device, for example, in order to shut down the laser. The Power signal 416 supplies operating power to the laser driver 105.

The outputs of the exemplary illustrated laser driver 105 include a power signal 410, as well as a laser bias current 412 and a modulation current 414 that control output characteristics of the TOSA 103. In this regard, a power monitor 422, exemplified as a photodiode, of the TOSA 103 monitors the output power of the TOSA and transmits a corresponding Output Power 408 signal back to the controller IC 110.

On the receive side, the ROSA 102 transmits Received Power 402 back to the postamp 104. The postamp 104 then conditions the signal and transmits the electrical data signal 404, denoted as comprising the channels RX+and RX−. Additionally, the postamp 104 transmits a loss of signal (“LOS”) signal 406 in the event that the received power 402 does not conform with established criteria.

III. Exemplary Transceiver Modules and Associated Pin Configurations

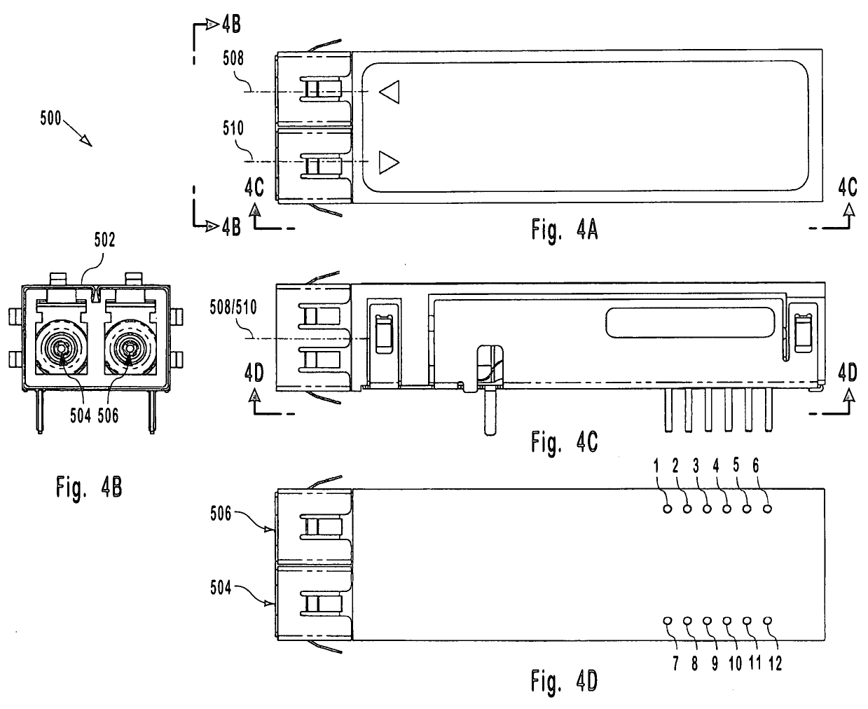

Reference is first made to FIGS. 4A through 4D, where FIG. 4A is a top view of an exemplary implementation of an optical transceiver module 500. As indicated in the front view of the optical transceiver module 500 depicted in FIG. 4B, the optical transceiver module 500 includes a housing 502, an optical transmitter 504 positioned at least partially within the housing 502, and an optical receiver 506 positioned at least partially within the housing 502. In this implementation, the optical transmitter 504 forms part of a TOSA and the optical receiver 506 forms part of a ROSA. As seen in FIGS. 4A and 4C, the optical transmitter 504 is configured for transmitting light along a first axis 508, while the optical receiver 506 is configured for receiving light along a second axis 510. In the illustrated implementation, the first axis 508 is substantially parallel to the second axis 510.

Additionally, as described above, the optical transceiver module 500 may also further include some or all of the following components (not shown): a laser driver; a laser bias controller; a power controller; a pre-amplifier; a post-amplifier; a laser wavelength controller; a main controller; a electrothermal cooler; an analog-to-digital converter; a digital-to-analog converter; an avalanche photodiode (“APD”) bias controller; and/or comparable component(s), positioned within the housing 502. Additionally, the external appearance of the optical transceiver module 500 is similar to that of existing 2×5 SFF optical transceivers, except that the optical transceiver module 500 includes two additional pins for accessing the controller IC 110 (FIG. 1).

As indicated in FIGS. 4C and 4D, a total of 12 pins is provided in the optical transceiver module 500, namely, an array comprising a first row of pins 2-6 and a second row of pins 8-12. In addition to the pin array, pins 1 and 7 are also provided that, as discussed in further detail below, enable communication by way of a serial digital interface of the controller IC 110.

In the illustrated embodiment, pins 2-6 and 8-12 correspond to the 2×5 pins of a typical 2×5 SFF optical transceiver modules. In at least some embodiments, pins 1-6 are spaced substantially equidistant from one another, that is, the pin arrangement has a substantially constant pitch. Similarly, the pin arrangement of pins 7-12 has a substantially constant pitch. Moreover, the first row of pins 1-6 is substantially parallel to the second row of pins 7-12 in the illustrated embodiment.

As indicated in FIG. 4D, pin 1 is interposed between pins 2-6 and the optical transmitter 504 and optical receiver 506, while pin 7 is positioned between pin 8-12 and the optical transmitter 504 and the optical receiver 506. Thus, this exemplary embodiment of the optical transceiver module 500 may be referred to as a 2×6 SFF optical transceiver module since the optical transceiver module 500 includes 2 rows of 6 pins each. In this embodiment then, the pins 1 and 7 are each located proximate a row of the 10 pin array. As discussed below however, pins 1 and 7 may be located in various other locations, relative to the pin array, as well.

With continuing reference to FIG. 4D, the additional pins 1 and 7 enable host access to the controller IC 110 and onboard diagnostics. More particularly, additional pins 1 and 7 are configured to serially communicate digital diagnostic information between the controller IC 110 and a host. Accordingly, pin 1 is coupled to the SDA line 16 and pin 7 is coupled to the SCL line 15 of the serial interface 121. Of course, other configurations may be employed as well. Thus, in one alternative embodiment, the functions associated with pins 1 and 7 are reversed, so that pin 1 is coupled to the SCL line 15 and pin 7 is coupled to the SDA line 16.

With further reference to their physical configuration and arrangement, the pins in the exemplary illustrated arrangement extend away from the housing 502 at an angle such that the pins are substantially perpendicular to the first and second axes 508 and 510, as best illustrated in FIG. 4C. Also, pins 1-6 and 7-12 are implemented as header connectors in at least some implementations. In particular, the pin fields are positioned in a plastic housing that mounts directly onto a printed board (not shown). The plastic mounting provides both insulation and stability to the elongate pins. Also, the pins may be configured for repeated pluggablility into corresponding female sockets coupled to the printed circuit board.

As regards the functionality associated with the other pins, the illustrated embodiment is configured so that functions are assigned to the pins as follows: pin 2 is a receiver ground pin; pin 3 is a receiver power pin, which is exemplarily coupled to a power supply operating at +3.3V; pin 4 is a signal detect pin; pin 5 is a receive data (Data Out) inverted pin; pin 6 is a receive data (Data Out) pin; pin 8 is a transmitter power pin, which is typically coupled to a power supply operating at +3.3V; pin 9 is a transmitter ground pin; pin 10 is a transmitter disable pin; pin 11 is a transmit data (Data In) pin; and pin 12 is a transmit data (Data In) inverted pin. This exemplary assignment of functions to pins is consistent with industry standards, including the Small Form Factor Multisource Agreement (“SFF MSA”).

With particular reference to the transmitter disable pin 10, it should be noted that in some alternative embodiments, the transmitter disable pin (“TxDisable”) may alternatively function as an interrupt pin. In use, when a potential problem is diagnosed by the controller IC 110, the controller IC 110 notifies the host of a potential problem by transmitting a signal out of the interrupt pin. This prompts the host to poll or query the onboard diagnostics provided by the controller IC 110 via the serial digital interface exemplified by the combination of SDA pin 1 and the SCL pin 7. In yet another embodiment, the same pin may be used as both a TxDisable pin and an interrupt pin using techniques such as multiplexing.

Inclusion of an interrupt pin, or interrupt signaling function, means that the computational overhead on the host device may be substantially reduced, because the host device will no longer have to periodically query the transceiver module 100 to determine if the transceiver module 100 has encountered any operational problems. Rather, the host device will need to query the transceiver module 100 much less often than if the transceiver module I 00 did not have an interrupt pin or function.

For example, the host device might periodically query the transceiver module 100 to determine the transceiver module 100 status only once per day, or some other suitably long period of time, instead of on a much more frequent basis, with the host device relying on the interrupt pin or function to signal it if any operational problem has developed during the intervening period. Employment of this interrupt functionality means that only a relatively small fraction of host device resources are required to monitor the performance of the transceiver module 100.

With continuing reference now to the embodiment illustrated in FIG. 4D, and with particular reference to the pin arrangement, the first pin 1 is an SDA pin and the seventh pin 7 is an SCL pin. Alternatively however, any of the pins may be used for the following functionality: a serial communication data pin, a receiver ground pin, a receiver power pin, a signal detect pin, a receive data inverted pin, a receive data pin, a serial communication clock pin, a transmitter power pin, a transmitter ground pin, a transmitter disable pin, a transmit data pin, a transmit data inverted pin, a loss of signal pin, or the like.

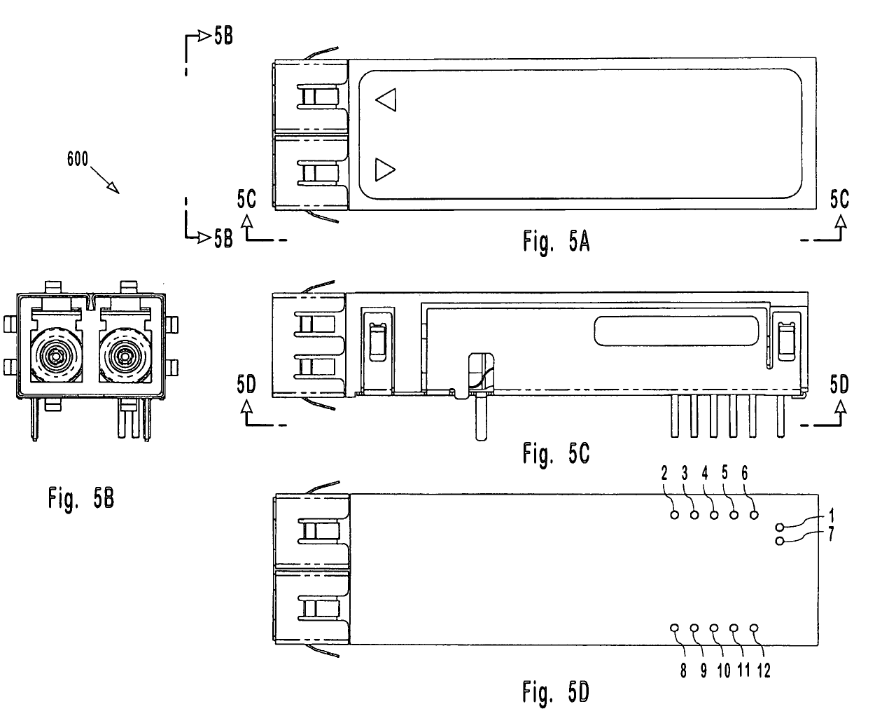

Directing attention now to FIGS. 5A through 5D, details are provided concerning an alternative embodiment of an optical transceiver module, denoted generally at 600. As indicated in FIGS. 5C and 5D, the pins 2-6 and 8-12 correspond to those of a standard 2×5 SFF optical transceiver. Further, optical transceiver module 600 is similar to the optical transceiver module 500 shown in FIGS. 4A through 4D except that the additional pins for serial communication, namely pins 1 and 7, are positioned behind and to one side of the array of 2×5 pins, as best illustrated in FIG. 5D. That is, the pins 1 and 7 are positioned on an opposite side of the array of 2×5 pins to the transmitter and receiver, and nearer to the row that includes pins 2-6.

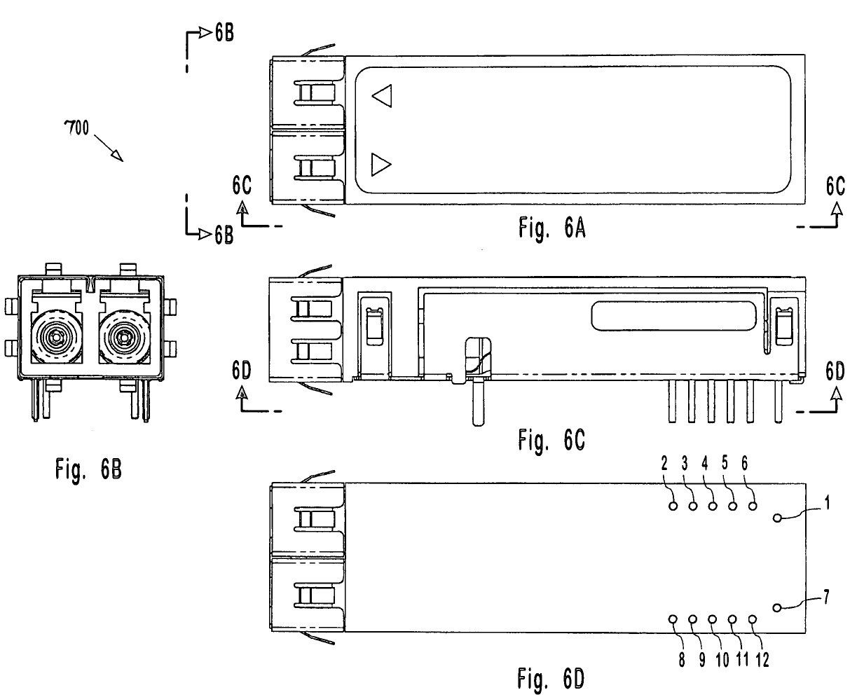

Yet another exemplary optical transceiver module, denoted at 700, is indicated in FIGS. 6A through 6D. Generally, the pins 2-6 and 8-12 of the optical transceiver module 700 correspond to those of a standard 2×5 SFF optical transceiver, such as the optical transceiver module 600 indicated in FIGS. 5A through 5D. More specifically, the optical transceiver module 700 is similar to the optical transceiver module 600 shown in FIGS. 5A through 5D except that in the case of the optical transceiver module 700, the additional pins for serial communication, namely pins 1 and 7, are positioned behind and to the center of the array of 2×5 pins. That is, pins 1 and 7 are positioned on an opposite side of the 2×5 pins to the transmitter and receiver, and between the row of pins 2-6 and the row of pins 8-12, as best illustrated in FIG. 6D.

It should be noted with respect to the exemplary implementations of an optical transceiver module illustrated, respectively in FIGS. 4A through 4D, 5A through 5D, and 6A through 6D, that various other pin arrangements may alternatively be employed. Accordingly, the scope of the invention is not limited to the exemplary illustrated pin configurations and arrangements. More generally, any other pin configurations and arrangements capable of implementing functionality comparable to that disclosed herein may be employed as well.

As disclosed herein then, the exemplary optical transceiver modules 500, 600, and 700 include various functionality such as, but not limited to, diagnostic functionality, that can be accessed by an external host via a digital serial interface, exemplarily implemented as a set of least two additional pins extending from the bottom of the housing of the optical transceiver. Among other things, this exemplary serial interface configuration enables standardized packaging, footprint, and form factor requirements to be met, while providing access to the additional functionality, such as onboard diagnostics, within the optical transceiver module.

Of course, many modifications and variations are possible in view of the disclosure herein. For example, other embodiments may include fewer or more components, different combinations of components, and/or different locations of the serial interface. Further, while various combinations of functions are indicated in exemplary embodiments of the controller IC, such combinations are not intended to limit the scope of the invention in any way. In fact, a wide variety of functionalities may be employed in various embodiments of the controller IC. It should also be pointed out that the controller IC of the present invention is suitable for application in multichannel optical links. As well, embodiments of the invention extend to various transmitters and receivers, and not solely to transceivers.

Following are various exemplary tables, referred to elsewhere herein, such as may be employed in connection with various embodiments of the invention.

TABLE 1
MEMORY MAP FOR TRANSCEIVER CONTROLLER

| Memory | | |
|---|---|---|
| Location | | |
| (Array0) | Name of Location | Function |
| 00h-5Fh | IEEE Data | This memory block is used to store |
| | | required GBIC data |
| 60h | Temperature MSB | This byte contains the MSB of the 15-bit |
| | | 2′s complement temperature output from |
| | | the temperature sensor. |
| 61h | Temperature LSB | This byte contains the LSB of the 15-bit |
| | | 2′s complement temperature output from |
| | | the temperature sensor. |
| | | (LSB is 0b). |
| 62h-63h | V_{cc} Value | These bytes contain the MSB (62h) and |
| | | the LSB (63h) of the measured V_{cc} |
| | | (15-bit number, with a 0b LSbit) |
| 64h-65h | Bᵢₙ Value | These bytes contain the MSB (64h) and |
| | | the LSB (65h) of the measured Bᵢₙ |
| | | (15-bit number, with a 0b LSbit) |
| 66h-67h | Pᵢₙ Value | These bytes contain the MSB (66h) and |
| | | the LSB (67h) of the measured Pᵢₙ |
| | | (15-bit number, with a 0b LSbit) |
| 68h-69h | Rᵢₙ Value | These bytes contain the MSB (68h) and |
| | | the LSB (69h) of the measured Rᵢₙ |
| | | (15-bit number, with a 0b LSbit) |
| 6Ah-6Dh | Reserved | Reserved |
| 6Eh | IO States | This byte shows the logical value of the |
| | | I/O pins. |
| 6Fh | A/D Updated | Allows the user to verify if an update |
| | | from the A/D has occurred to the 5 |
| | | values: temperature, V_{cc}, Bᵢₙ, Pᵢₙ and Rᵢₙ. |
| | | The user writes the byte to 00h. Once a |
| | | conversion is complete for a give value, |
| | | its bit will change to ‘1’. |
| 70h-73h | Alarm Flags | These bits reflect the state of the alarms |
| | | as a conversion updates. High alarm bits |
| | | are ‘1’ if converted value is greater than |
| | | corresponding high limit. Low alarm bits |
| | | are ‘1’ if converted value is less than |
| | | corresponding low limit. Otherwise, bits |
| | | are 0b. |
| 74h-77h | Warning Flags | These bits reflect the state of the |
| | | warnings as a conversion updates. High |
| | | warning bits are ‘1’ if converted value is |
| | | greater than corresponding high limit. |
| | | Low warning bits are ‘1’ if converted |
| | | value is less than corresponding low |
| | | limit. Otherwise, bits are 0b. |
| 78h-7Ah | Reserved | Reserved |
| 7Bh-7Eh | Password Entry Bytes | The four bytes are used for password |
| | PWE Byte 3 (7Bh) | entry. The entered password will |
| | MSByte | determine the user's read/write privileges. |
| | PWE Byte 2 (7Ch) | |
| | PWE Byte 1 (7Dh) | |
| | PWE Byte 0 (7Eh) | |
| | LSByte | |
| 7Fh | Array Select | Writing to this byte determines which of |
| | | the upper pages of memory is selected for |
| | | reading and writing. |
| | | 0xh (Array x Selected) |
| | | Where x = 1, 2, 3, 4 or 5 |
| 80h-F7h | | Customer EEPROM |
| 87h | DA % Adj | Scale output of D/A converters by |
| | | specified percentage |
| | Name of Location | Function of Location |
| Memory | | |
| Location | | |
| (Array 1) | | |
| 00h-FFh | | Data EEPROM |
| Memory | | |
| Location | | |
| (Array 2) | | |
| 00h-Ffh | | Data EEPROM |
| Memory | | |
| Location | | |
| (Array 3) | | |
| 80h-81h | Temperature High | The value written to this location serves |
| 88h-89h | Alarm | as thehigh alarm limit. Data format is |
| 90h-91h | V_{cc} High Alarm | the |
| 98h-99h | Bᵢₙ High Alarm | same as the corresponding value |
| A0h-A1h | Pᵢₙ High Alarm | (temperature, V_{cc}, Bᵢₙ, Pᵢₙ, Rᵢₙ). |
| | Rᵢₙ High Alarm | |
| 82h-83h | Temperature Low | The value written to this location serves |
| 8Ah-8Bh | Alarm | as the low alarm limit. Data format is the |
| 92h-93h | V_{cc} Low Alarm | same as the corresponding value |
| 9Ah-9Bh | Bᵢₙ Low Alarm | (temperature, V_{cc}, Bᵢₙ, Pᵢₙ, Rᵢₙ). |
| A2h-A3h | Pᵢₙ Low Alarm | |
| | Rᵢₙ Low Alarm | |
| 84h-85h | Temp High Warning | The value written to this location serves |
| 8Ch-8Dh | V_{cc} High Warning | as the high warning limit. Data format is |
| 94h-95h | Bᵢₙ High Warning | the same as the corresponding value |
| 9Ch-9Dh | Pᵢₙ High Warning | (temperature, V_{cc}, Bᵢₙ, Pᵢₙ, Rᵢₙ). |
| A4h-A5h | Rᵢₙ High Warning | |
| 86h-87h | Temperature Low | The value written to this location serves |
| 8Eh-8Fh | Warning | as the low warning limit. Data format is |
| 96h-97h | V_{cc} Low Warning | the same as the corresponding value |
| 9Eh-9Fh | Bᵢₙ Low Warning | (temperature, V_{cc}, Bᵢₙ, Pᵢₙ, Rᵢₙ). |
| A6h-A7h | Pᵢₙ Low Warning | |
| | Rᵢₙ Low Warning | |
| A8h-AFh, | Dₒᵤₜ control 0-8 | Individual bit locations are defined in |
| C5h | Fₒᵤₜ control 0-8 | Table 4. |
| B0h-B7h, C6h | Lₒᵤₜ control 0-8 | |
| B8h-BFh, C7h | | |
| C0h | Reserved | Reserved |
| C1h | Prescale | Selects MCLK divisor for X-delay |
| | | CLKS. |
| C2h | Dₒᵤₜ Delay | Selects number of prescale clocks |
| C3h | Fₒᵤₜ Delay | |
| C4h | Lₒᵤₜ Delay | |
| C8h-C9h | V_{cc} - A/D Scale | 16 bits of gain adjustment for |
| CAh-CBh | Bᵢₙ - A/D Scale | corresponding A/D conversion values. |
| CCh-CDh | Pᵢₙ - A/D Scale | |
| CEh-CFh | Rᵢₙ - A/D Scale | |
| D0h | Chip Address | Selects chip address when external pin |
| | | ASEL is low. |
| D1h | Margin #2 | Finisar Selective Percentage (FSP) for |
| | | D/A #2 |
| D2h | Margin #1 | Finisar Selective Percentage (FSP) for |
| | | D/A #1 |
| D3h-D6h | PW1 Byte 3 (D3h) | The four bytes are used for password 1 |
| | MSB | entry. The entered password will |
| | PW1 Byte 2 (D4h) | determine the customer's read/write |
| | PW1 Byte 1 (D5h) | privileges. |
| | PW1 Byte 0 (D6h) LSB | |
| D7h | D/A Control | This byte determines if the D/A outputs |
| | | source or sink current, and it allows for |
| | | the outputs to be scaled. |
| D8h-DFh | Bᵢₙ Fast Trip | These bytes define the fast trip |
| | | comparison over temperature. |
| E0h-E3h | Pᵢₙ Fast Trip | These bytes define the fast trip |
| | | comparison over temperature. |
| E4h-E7h | Rᵢₙ Fast Trip | These bytes define the fast trip |
| | | comparison over temperature. |
| E8h | Configuration Override | Location of the bits is defined in Table 4 |
| | Byte | |
| E9h | Reserved | Reserved |
| EAh-EBh | Internal State Bytes | Location of the bits is defined in Table 4 |
| ECh | I/O States 1 | Location of the bits is defined in Table 4 |
| EDh-EEh | D/A Out | Magnitude of the temperature |
| | | compensated D/A outputs |
| EFh | Temperature Index | Address pointer to the look-up Arrays |
| F0h-FFh | Reserved | Reserved |
| Memory | | |
| Location | | |
| (Array 4) | | |
| 00h-Ffh | | D/A Current vs. Temp #1 |
| | | (User-Defined Look-up Array #1) |
| Memory | | |
| Location | | |
| (Array 5) | | |
| 00h-Ffh | | D/A Current vs. Temp #2 |
| | | (User-Defined Look-up Array #2) |

TABLE 2
DETAIL MEMORY DESCRIPTIONS - A/D
VALUES AND STATUS BITS

| | | | |
|---|---|---|---|
| Byte | Bit | Name | Description |

Converted analog values. Calibrated 16 bit data. (See Notes 1-2)

| | | | |
|---|---|---|---|
| 96 | All | Temperature | Signed 2′ s complement integer |
| (60h) | | MSB | temperature (−40 to + 125 C) |
| | | | Based on internal temperature |
| | | | measurement |
| 97 | All | Temperature | Fractional part of temperature |
| | | LSB | (count/256) |
| 98 | All | V_{cc} MSB | Internally measured supply voltage in |
| | | | transceiver. Actual voltage is full 16 bit |
| | | | value * 100 uVolt. |
| 99 | All | V_{cc} LSB | (Yields range of 0-6.55 V) |
| 100 | All | TX Bias MSB | Measured TX Bias Current in mA Bias |
| | | | current is full 16 bit value * (1/256) mA. |
| 101 | All | TX Bias LSB | (Full range of 0-256 mA possible with 4 |
| | | | uA resolution) |
| 102 | All | TX Power | Measured TX output power in mW. |
| | | MSB | Output is full 16 bit value * (1/2048) mW. |
| | | | (see note 5) |
| 103 | All | TX Power LSB | (Full range of 0-32 mW possible with |
| | | | 0.5 μW resolution, or −33 to +15 dBm |
| 104 | All | RX Power | Measured RX input power in mW RX |
| | | MSB | power is full 16 bit value * |
| | | | (1/16384) mW. (see note 6) |
| 105 | All | RX Power LSB | (Full range of 0-4 mW possible with |
| | | | 0.06 μW resolution, or −42 to +6 dBm) |
| 106 | All | Reserved MSB | Reserved for 1st future definition of |
| | | | digitized analog input |
| 107 | All | Reserved LSB | Reserved for 1st future definition of |
| | | | digitized analog input |
| 108 | All | Reserved MSB | Reserved for 2nd future definition of |
| | | | digitized analog input |
| 109 | All | Reserved LSB | Reserved for 2nd future definition of |
| | | | digitized analog input |
| 110 | 7 | TX Disable | Digital state of the TX Disable Input Pin |
| 110 | 6 | Reserved | |
| 110 | 5 | Reserved | |
| 110 | 4 | Rate Select | Digital state of the SFP Rate Select Input |
| | | | Pin |
| 110 | 3 | Reserved | |
| 110 | 2 | TX Fault | Digital state of the TX Fault Output Pin |
| 110 | 1 | LOS | Digital state of the LOS Output Pin |
| 110 | 0 | Power-On- | Indicates transceiver has achieved power |
| | | Logic | up and data valid |
| 111 | 7 | Temp A/D | Indicates A/D value in Bytes 96/97 is |
| | | Valid | valid |
| 111 | 6 | V_{cc} A/D | Indicates A/D value in Bytes 98/99 is |
| | | Valid | valid |
| 111 | 5 | TX Bias | Indicates A/D value in Bytes 100/101 is |
| | | A/D Valid | valid |
| 111 | 4 | TX Power | Indicates A/D value in Bytes 102/103 is |
| | | A/D Valid | valid |
| 111 | 3 | RX Power | Indicates A/D value in Bytes 104/105 is |
| | | A/D Valid | valid |
| 111 | 2 | Reserved | Indicates A/D value in Bytes 106/107 is |
| | | | valid |
| 111 | 1 | Reserved | Indicates A/D value in Bytes 108/109 is |
| | | | valid |
| 111 | 0 | Reserved | Reserved |

TABLE 3
DETAIL MEMORY DESCRIPTIONS - ALARM
AND WARNING FLAG BITS

| | | Alarm and Warning Flag Bits | |
|---|---|---|---|
| Byte | Bit | Name | Description |
| 112 | 7 | Temp High Alarm | Set when internal temperature |
| | | | exceeds high alarm level. |
| 112 | 6 | Temp Low Alarm | Set when internal temperature is |
| | | | below low alarm level. |
| 112 | 5 | V_{cc} High Alarm | Set when internal supply voltage |
| | | | exceeds high alarm level. |
| 112 | 4 | V_{cc} Low Alarm | Set when internal supply voltage is |
| | | | below low alarm level. |
| 112 | 3 | TX Bias High Alarm | Set when TX Bias current |
| | | | exceeds high alarm level. |
| 112 | 2 | TX Bias Low Alarm | Set when TX Bias current is |
| | | | below low alarm level. |
| 112 | 1 | TX Power High Alarm | Set when TX output power |
| | | | exceeds high alarm level. |
| 112 | 0 | TX Power Low Alarm | Set when TX output power is |
| | | | below low alarm level. |
| 113 | 7 | RX Power High Alarm | Set when Received Power |
| | | | exceeds high alarm level. |
| 113 | 6 | RX Power Low Alarm | Set when Received Power is |
| | | | below low alarm level. |
| 113 | 5- | Reserved Alarm | |
| | 0 | | |
| 114 | All | Reserved | |
| 115 | All | Reserved | |
| 116 | 7 | Temp High Warning | Set when internal temperature |
| | | | exceeds high warning level. |
| 116 | 6 | Temp Low Warning | Set when internal temperature |
| | | | is below low warning level. |
| 116 | 5 | V_{cc} High Warning | Set when internal supply voltage |
| | | | exceeds high warning level. |
| 116 | 4 | V_{cc} Low Warning | Set when internal supply voltage |
| | | | is below low warning level. |
| 116 | 3 | TX Bias High Warning | Set when TX Bias current |
| | | | exceeds high warning level. |
| 116 | 2 | TX Bias Low Warning | Set when TX Bias current is |
| | | | below low warning level. |
| 116 | 1 | TX Power High Warning | Set when TX output power |
| | | | exceeds high warning level. |
| 116 | 0 | TX Power Low Warning | Set when TX output power is |
| | | | below low warning level. |
| 117 | 7 | RX Power High Warning | Set when Received Power |
| | | | exceeds high warning level. |
| 117 | 6 | RX Power Low Warning | Set when Received Power is |
| | | | below low warning level. |
| 117 | 5 | Reserved Warning | |
| 117 | 4 | Reserved Warning | |
| 117 | 3 | Reserved Warning | |
| 117 | 2 | Reserved Warning | |
| 117 | 1 | Reserved Warning | |
| 117 | 0 | Reserved Warning | |
| 118 | All | Reserved | |
| 119 | All | Reserved | |

TABLE 4
CONFIGURATION FLAGS

| Byte Name | Bit 7 | Bit 6 | Bit 5 | Bit 4 | Bit 3 | Bit 2 | Bit I | Bit 0 |
|---|---|---|---|---|---|---|---|---|
| X-out cntl0 | T alrm hi | T alrm lo | V alrm hi | V alrm lo | B alrm hi | B alrm lo | P alrm hi | P alrm lo |
| | set | set | set | set | set | set | set | set |
| X-out cntl1 | R alrm hi | R alrm lo | B ft hi set | P ft hi set | R ft hi set | D-in inv | D-in set | F-in inv |
| | set | set | | | | set | | set |
| X-out cntl2 | F-in set | L-in inv | L-in set | Aux inv | Aux set | T alrm hi | T alrm lo | V alrm hi |
| | | set | | set | | hib | hib | hib |
| X-out cntl3 | V alrm lo | B alrm hi | B alrm lo | P alrm hi | P alrm lo | R alrm hi | R alrm lo | B ft hi hib |
| | hib | hib | hib | hib | hib | hib | hib | |
| X-out cntl4 | P ft hi hib | R ft hi hib | D-in inv | D-in hib | F-in inv | F-in hib | L-in inv | L-in hib |
| | | | hib | | hib | | hib | |
| X-out cntl5 | Aux inv | Aux hib | T alrm hi | T alrm lo | V alrm hi | V alrm lo | B alrm hi | B alrm lo |
| | hib | | clr | clr | clr | clr | clr | clr |
| X-out cntl6 | P alrm hi | P alrm lo | R alrm hi | R alrm lo | B ft hi clr | P ft hi clr | R ft hi clr | D-in inv |
| | clr | clr | clr | clr | | | | clr |
| X-out cntl7 | D-in clr | F-in inv | F-in clr | L-in inv | L-in clr | Aux inv | Aux clr | EE |
| | | clr | | clr | | clr | | |
| X-out cntl8 | latch | invert | o-ride data | a-ride | S reset | HI enable | LO enable | Pullup |
| | select | | | select | data | | | enable |
| Prescale | reserved | reserved | Reserved | reserved | B³ | B² | B¹ | B⁰ |
| X-out | B⁷ | B⁶ | B⁵ | B⁴ | B³ | B² | B¹ | B⁰ |
| delay | | | | | | | | |
| chip | b⁷ | b⁶ | b⁵ | b⁴ | b³ | b² | b¹ | X |
| address | | | | | | | | |
| X-ad scale | 2¹⁵ | 2¹⁴ | 2¹³ | 2¹² | 2¹¹ | 2¹⁰ | 2⁹ | 2⁸ |
| MSB | | | | | | | | |
| X-ad scale | 2⁷ | 2⁶ | 2⁵ | 2⁴ | 2³ | 2² | 2¹ | 2⁰ |
| LSB | | | | | | | | |
| D/A cntl | source/ | D/A #2 range | | | source/ | | D/A #I range | |
| | sink | | | | sink | | | |
| | 1/0 | 2² | 2¹ | 2⁰ | 1/0 | 2² | 2¹ | 2⁰ |
| config/O- | manual | manual | manual | EE Bar | SW-POR | A/D | Manual | reserved |
| ride | D/A | index | AD alarm | | | Enable | fast alarm | |
| Internal | D-set | D-inhibit | D-delay | D-clear | F-set | F-inhibit | F-delay | F-clear |
| State 1 | | | | | | | | |
| Internal | L-set | L-inhibit | L-delay | L-clear | reserved | reserved | reserved | reserved |
| State 0 | | | | | | | | |
| I/O States 1 | reserved | F-in | L-in | reserved | D-out | reserved | reserved | reserved |
| Margin #1 | Reserved | Neg_{—} | Neg_{—} | Neg_{—} | Reserved | Pos_{—} | Pos_{—} | Pos_{—} |
| | | Scale2 | Scale1 | Scale0 | | Scale2 | Scale1 | Scale0 |
| Margin #2 | Reserved | Neg_{—} | Neg_{—} | Neg_{—} | Reserved | Pos_{—} | Pos_{—} | Pos_{—} |
| | | Scale2 | Scale1 | Scale0 | | Scale2 | Scale1 | Scale0 |

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. An optoelectronic module, comprising:
a housing;
an optoelectronic component substantially disposed within the housing;
a controller IC disposed within the housing and including a serial digital interface configured to facilitate communication, between the optoelectronic module and a host, of diagnostic parameter information concerning the optoelectronic component; and
a pinout arrangement comprising:
a pin array having a plurality of pins, at least some of which are in communication with the controller IC; and
a pair of pins in communication with the serial digital interface, each of the pair of pins also being configured and arranged for communication with the host by way of a corresponding interface line.

2. The optoelectronic module as recited in claim 1, wherein the optoelectronic component comprises at least one of: a transmit optical subassembly; and, a receive optical subassembly.

3. The optoelectronic module as recited in claim 1, wherein the serial digital interface is compatible with one of: I²C serial communication; or, MDIO serial communication.

4. The optoelectronic module as recited in claim 1, wherein the controller IC is configured to receive from the host, by way of at least one of the pair of pins, at least one of the following: a command; data; and, diagnostic parameter information.

5. The optoelectronic module as recited in claim 1, wherein one of the pair of pins is configured to communicate with the host by way of an SDA interface line, and the other of the pair of pins is configured to communicate with the host by way of an SCL interface line.

6. The optoelectronic module as recited in claim 1, wherein the pin array is configured and arranged for substantial conformity with the SFF configuration standard.

7. The optoelectronic module as recited in claim 1, wherein the pin array comprises one of: a 2×5 pin arrangement; and, a 2×10 pin arrangement.

8. The optoelectronic module as recited in claim 1, wherein the diagnostic parameter information includes at least one of: warning information; alarm information; and, status information.

9. The optoelectronic module as recited in claim 1, wherein one of the pair of pins comprises a serial communication data pin, and the other of the pair of pins comprises a serial communication clock pin.

10. The optoelectronic module as recited in claim 1, wherein the pair of pins is configured for repeated pluggability.

11. The optoelectronic module as recited in claim 1, wherein the controller IC is configured to generate at least one of: a temperature dependent output; and, a temperature independent output.

12. The optoelectronic module as recited in claim 1, wherein the controller IC further comprises an analog monitoring connection.

13. The optoelectronic module as recited in claim 1, wherein the serial digital interface substantially conforms to one of: a GBIC standard; and, the SFF standard.

14. The optoelectronic module as recited in claim 1, wherein the optoelectronic module is configured to receive a “rate select” signal from the host by way of one of the pins of the pinout arrangement.

15. The optoelectronic module as recited in claim 1, wherein the optoelectronic module is configured to transmit a “transmitter fault” signal to the host by way of one of the pins of the pinout arrangement.

16. The optoelectronic module as recited in claim 1, further comprising a plurality of memory mapped locations, at least one of which is accessible by way of the serial digital interface.

17. An optical transceiver module, comprising:
a housing;
a transmit optical subassembly substantially disposed within the housing;
a receive optical subassembly substantially disposed within the housing;
a controller IC disposed within the housing and including:
a serial digital interface configured and arranged to facilitate communication, between the optical transceiver module and a host, of diagnostic parameter information relating to at least one of: the transmit optical subassembly; and, the receive optical subassembly; and
a plurality of memory mapped locations, at least one of which is configured to store diagnostic parameter information and is accessible by way of the serial digital interface; and a pinout arrangement comprising:
a pin array having a plurality of pins, at least some of which are in communication with the controller IC; and
a pair of pins in communication with the serial digital interface, each of the pair of pins also being configured and arranged for communication with the host by way of a corresponding interface line.

18. The optical transceiver module as recited in claim 17, wherein the serial digital interface is compatible with one of: I²C serial communication; or, MDIO serial communication.

19. The optical transceiver module as recited in claim 17, wherein the controller IC is configured to receive from the host, by way of at least one of the pair of pins, at least one of the following: a command; data; and, diagnostic parameter information.

20. The optical transceiver module as recited in claim 17, wherein one of the pair of pins is configured to communicate with the host by way of an SDA interface line, and the other of the pair of pins is configured to communicate with the host by way of an SCL interface line.

21. The optical transceiver module as recited in claim 17, wherein the pin array is configured and arranged for substantial conformity with the SFF configuration standard.

22. The optical transceiver module as recited in claim 17, wherein the pin array comprises one of: a 2×5 pin arrangement; and, a 2×10 pin arrangement.

23. The optical transceiver module as recited in claim 17, wherein the diagnostic parameter information includes at least one of: warning information; alarm information; and, status information.

24. The optical transceiver module as recited in claim 17, wherein one of the pair of pins comprises a serial communication data pin, and the other of the pair of pins comprises a serial communication clock pin.

25. The optical transceiver module as recited in claim 17, wherein the pair of pins is configured for repeated pluggability.

26. The optical transceiver module as recited in claim 17, wherein at least one of the plurality of memory mapped locations is implemented as a register.

27. The optical transceiver module as recited in claim 17, wherein at least one of the plurality of memory mapped locations is configured to be read, and written to, by way of the serial digital interface.

28. The optical transceiver module as recited in claim 17, wherein at least one of the memory mapped locations is configured to receive and store information concerning at least one of the following diagnostic parameters: a bias current associated with the transmit optical subassembly; optical transmit power associated with the transmit optical subassembly; received signal power; supply voltage; laser temperature; operation time; and, polarity and type of input and output signals.

29. The optical transceiver module as recited in claim 17, wherein the diagnostic parameter information stored in the at least one memory mapped location is in a digitized form.

30. The optical transceiver module as recited in claim 17, wherein the pin array comprises two rows of six pins each, each pin of the two rows of six pins comprising one of the following: a serial communication data pin; a receiver ground pin; a receiver power pin; a signal detect pin; a receive data inverted pin; a receive data pin; a serial communication clock pin; a transmitter power pin; a transmitter ground pin; a transmitter disable pin; a transmit data pin; a transmit data inverted pin; an interrupt pin; and a loss of signal pin.

31. The optical transceiver module as recited in claim 17, further comprising one or more of: a laser driver; a laser bias controller; a power controller; a pre-amplifier; a post-amplifier; a laser wavelength controller; a main controller; an electrothermal cooler; an analog-to-digital converter; a digital-to analog converter; and, an avalanche photodiode bias controller.

32. The optical transceiver module as recited in claim 17, wherein the optical transceiver module is configured to receive a “rate select” signal from the host by way of one of the pins of the pinout arrangement.

33. The optical transceiver module as recited in claim 32, wherein the “rate select” signal includes at least “high” and “low” Values, each of which corresponds to a different data rate.

34. The optical transceiver as recited in claim 32, wherein the “rate select” signal is received from the host by way of one of the pair of pins.

35. The optical transceiver module as recited in claim 17, wherein the optical module is configured to transmit a “transmitter fault” signal to the host by way of one of the pins of the pinout arrangement.

36. The optical transceiver as recited in claim 35, wherein the “transmitter fault” signal is transmitted to the host by way of one of the pair of pins.

37. The optical transceiver module as recited in claim 17, wherein a memory map table associated with at least one of the plurality of memory map locations comprises information indicating at least one of: a storage location of a measured value of a diagnostic parameter; a storage location of a limit value for a diagnostic parameter; a storage location of a flag value for a diagnostic parameter; and, a storage location of a configuration value for a diagnostic parameter.

38. An optoelectronic module, comprising:
a housing;
an optoelectronic component substantially disposed within the housing;
a controller IC disposed within the housing and including a serial digital interface configured to facilitate communication, between the optoelectronic module and a host, of diagnostic parameter information concerning the optoelectronic component; and
a pinout arrangement comprising:
a pin array having a set of pins configured and arranged for substantial conformity with the SFF configuration standard; and
a pair of pins in communication with the serial digital interface, each of the pair of pins also being configured and arranged for communication with the host by way of a corresponding interface line.

39. The optoelectronic module as recited in claim 38, wherein the optoelectronic component comprises at least one of: a transmit optical subassembly; and, a receive optical subassembly.

40. The optoelectronic module as recited in claim 38, wherein the serial digital interface is compatible with one of: I²C serial communication; and MDIO serial communication.

41. The optoelectronic module as recited in claim 38, wherein the controller IC is configured to receive from the host, by way of one at least one of the pair of pins, at least one of the following: a command; data; and, diagnostic parameter information.

42. The optoelectronic module as recited in claim 38, wherein one of the pair of pins is configured to communicate with the host by way of an SDA interface line, and the other of the pair of pins is configured to communicate with the host by way of an SCL interface line.

43. The optoelectronic module as recited in claim 38, wherein the pin array comprises one of: a 2×5 pin arrangement; and, a 2×10 pin arrangement.

44. The optoelectronic module as recited in claim 38, wherein the diagnostic parameter information comprises at least one of: warning information; alarm information; a measured value of a diagnostic parameter; a limit value associated with a diagnostic parameter; a flag value associated with a diagnostic parameter; a configuration value associated with a diagnostic parameter; a bias current associated with the optoelectronic component; an optical transmit power associated with the optoelectronic component; and, a received signal power associated with the optoelectronic component.

45. The optoelectronic module as recited in claim 38, wherein one of the pair of pins comprises a serial communication data pin, and the other of the pair of pins comprises a serial communication clock pin.

46. The optoelectronic module as recited in claim 38, further comprising a plurality of memory mapped locations, at least one of which is accessible by way of the serial digital interface and which is configured to receive and store information concerning at least one diagnostic parameter.
